(19) United States
(12) Patent Application Publication
(10) Pub. No.: US 2011/0080964 A1
(43) Pub. Date: Apr. 7, 2011

(54) ADAPTIVE CODEBOOK FOR BEAMFORMING IN LIMITED FEEDBACK MIMO SYSTEMS

(75) Inventors: Davood Shamsi, Houston, TX (US); Kiarash Amiri, Houston, TX (US); Behnaam Aazhang, Houston, TX (US); Joseph R. Cavallaro, Pearland, TX (US); Jorma Olavi Lilleberg, Oulu (FI)

(73) Assignee: NOKIA CORPORATION, Espoo (FI)

(21) Appl. No.: 12/808,141

(22) PCT Filed: Dec. 12, 2007
(86) PCT No.: PCT/US2007/025358

§ 371 Date: Dec. 16, 2010

(51) Int. Cl. H04L 27/28

(52) U.S. Cl. 375/260

(57) ABSTRACT

A method for beamforming is described. The method includes generating a pseudo-random unitary matrix. A first codebook is rotated with the pseudo-random unitary matrix. The method includes generating a second codebook based upon the rotated codebook and a correlation matrix. A codeword is selected from the second codebook using a channel matrix. The correlation matrix is updated based upon the selected codeword. The method includes transmitting an index of the selected codeword in the codebook. The method includes receiving the codeword index. A codebook is consulted using the codeword index to locate a codeword. Beamforming is performed based upon the located codeword. An apparatus is also described.

### TECHNICAL FIELD

The exemplary embodiments of this invention relate generally to wireless communication systems and, more specifically, relate to multiple-input multiple-output (MIMO) systems which use limited feedback to enhance the performance.

### BACKGROUND

The following abbreviations are utilized herein:
3GPP 3rd Generation Partnership Project
BER bit error rate
E-UTRAN evolved UTRAN
i.i.d. independent and identically distributed
LFSR linear feedback shift register
LTE long-term evolution
MIMO multiple input multiple output
MRC maximal ratio combining
PHY physical layer
QAM quadrature amplitude modulation
QPSK quadrature phase-shift keying
SNR signal-to-noise ratio
SVD singular value decomposition
UMTS universal mobile telecommunications system
UTRAN UMTS terrestrial radio access network
WiMAX worldwide interoperability for microwave access

When using beamforming in a transmitter for a multiple-input multiple-output (MIMO) wireless system, having second order statistical characteristic of the channel in the transmitter is useful in order to select the best beamforming vector. Since channel information is available in the receiver, a limited feedback can inform the transmitter of a sub-optimal choice for beamforming vector.

A well-known technique for transmitting the channel state information to the transmitter in MIMO systems is quantized beamforming. In this scheme, illustrated in FIG. 1, for a M_{T}×M_{R} MIMO system 100 that includes a transmitter (Tx) 105 and a receiver (Rx) 110, the scalar information symbol, generally drawn from a modulation constellation set, is multiplied by a beamforming codeword (vector), wᵢ, and transmitted over the air. The beamforming codeword is chosen from a beamforming codebook, K, based on the feedback information provided by the receiver through a perfect feedback link. The beamforming codebook, K, known both to transmitter 105 and receiver 110, is assumed to be a matrix with its columns corresponding to different wᵢ. Thus, K would be a M_{T}×N, where N is the number of beamforming codewords (vectors) in the beamforming codebook. The transmitted vector, wᵢs, experiences fading, modeled with M_{R}×M_{T} channel matrix, and additive white Gaussian noise vector, n, and is received in the other end, given by:

x=Hwᵢs+n (1).

Finding codebook, K, is the main challenge in this problem.

The Grassmannian line packing technique has been a well-known method to generate the beamforming codebook, see D. J. Love, R. W. Heath and T. Strohmer, “Grassmannian Beamforming for Multiple-input Multiple-output Wireless Systems,” IEEE Transaction on Information Theory, vol. 49, pp. 2735-2747, October 2003. In this method, the beamforming codewords are selected such that they have the maximum mutual distances. However, this technique is optimal for channels without statistical correlations. Also, the beamforming codebook remains fixed during the transmission.

As shown in V. Raghavan, A. M. Sayeed and N. Boston, “Near-optimal Codebook Constructions for Limited-feedback Beamforming in Correlated MIMO Channels,” International Symposium on Information Theory, 2006, realistic channel models show temporal correlations as opposed to the conventional independent Rayleigh fading channel model. However, the well-known solution introduced in “Grassmannian Beamforming for Multiple-input Multiple-output Wireless Systems” is not able to exploit these correlations to further improve the accuracy of the feedback.

In order to address this issue, new methodologies have been proposed in D. J. Love and R. W. Heath Jr., “Grassmannian Beamforming on Correlated MIMO Channels,” Proceeding of Globecom, vol. 1, pp. 106-110, 2004 and A. Barg and D. Y. Nogin, “Bounds on Packings of Spheres in the Grassmann Manifold,” IEEE Transaction on Information Theory, vol. 48, pp. 2450-2454, September 2002; however, their codebooks are fixed codebooks in the sense that once they are designed for a specific transmitter, they are not adaptively changed as the channel changes. Therefore, all the previous beamforming/MRC methods are based on a fixed codebook.

In Liu, et al. “A Beamforming Method for Wireless Communication Systems and Apparatus for Performing the same” (WO/2007/022330) two different beamforming schemes a presented. One, a PVQ beamformer uses a transmit beamforming. In this technique, the beamforming codebook remains fixed after being constructed, throughout the whole transmission time. Also, this technique requires a large memory space for storing all the constructed codebooks for different values of a. The other technique presented is SBF beamforming. Both SBF and PVQ techniques assume a very specific channel model. Moreover, both SBF and PVQ techniques, only work for that specific channel model and may be subject to an estimation bias.

In R. Samanta and R. W. Heath, Jr., “Codebook Adaptation for Quantized MIMO Beamforming Systems” Proc. of the IEEE Asilomar Conf. on Signals, Systems, and Computers, pp. 376-380, Pacific Grove, Calif., USA, Oct. 30-Nov. 2, 2005, a codebook adaptation technique is proposed. In this technique there are a few different codebooks. These are all stored in a set, called a codeset; and based on the channel status, one of the codebooks is chosen. Then, using the selected codebook, the fixed codebook beamforming is performed. This technique constantly monitors the channel to find a reasonable codebook from the codeset. However because of the limited number of codebooks in the set, the technique still suffers from a minimum error between the codebooks in the set and an optimum codebook.

Finding an optimum codebook is the main challenge. Thus, an, adaptive method to keep a codebook optimal during the transmission is needed which uses a variable beamforming codebook. Such a method should be independent of channel model and perform very well for a general type of temporal/spatial correlated channel model.

### SUMMARY

An exemplary embodiment in accordance with this invention is a method for beamforming. The method includes generating a pseudo-random unitary matrix. A first codebook is rotated with the pseudo-random unitary matrix. The method includes generating a second codebook based upon the rotated codebook and a correlation matrix. A codeword is selected from the second codebook using a channel matrix. The correlation matrix is updated based upon the selected codeword. The method includes transmitting an index of the selected codeword in the codebook.

A further exemplary embodiment in accordance with this invention is a method for beamforming. The method includes receiving a codeword index. A first codebook is consulted using the codeword index to locate a codeword. The method includes generating a pseudo-random unitary matrix. A first codebook is rotated with the pseudo-random unitary matrix. The method includes generating a second codebook based upon the rotated codebook and a correlation matrix. The correlation matrix is updated based upon the codeword. Beamforming is performed based upon the codeword.

Another exemplary embodiment in accordance with this invention is an apparatus for beamforming. The apparatus includes a processing unit to generate a pseudo-random unitary matrix. The processing unit also rotates a first codebook with the pseudo-random unitary matrix, generates a second codebook based upon the rotated codebook and a correlation matrix, selects a codeword from the second codebook using a channel matrix, and updates the correlation matrix based on the selected codeword. The apparatus also includes a transmitter in the receiver unit configured to transmit an index of the selected codeword in the codebook.

A further exemplary embodiment in accordance with this invention is an apparatus for beamforming. The apparatus includes a receiver in the transmitter unit to receive an index of the selected codeword in the codebook. The apparatus includes a processing unit to consult a first codebook using the codeword index to locate a codeword. The processing unit also generates a pseudo-random unitary matrix, rotates a first codebook with the pseudo-random unitary matrix, generates a second codebook based upon the rotated codebook and a correlation matrix, and updates the correlation matrix based on the codeword. The apparatus includes a beamforming unit to perform beamforming based upon the codeword.

Another exemplary embodiment in accordance with this invention is an apparatus for beamforming. The apparatus includes a means for generating a pseudo-random unitary matrix. A matrix rotating means rotates a first codebook with the pseudo-random unitary matrix. The apparatus includes a means for generating a second codebook based upon the rotated codebook and a correlation matrix. A selecting means selects a codeword from the second codebook using a channel matrix. An updating means updates the correlation matrix based on the selected codeword. The apparatus includes a means for transmitting an index of the selected codeword in the codebook.

A further exemplary embodiment in accordance with this invention is an apparatus for beamforming. The apparatus includes a means for receiving a codeword index. A consulting means consults a first codebook using the codeword index to locate a codeword. The apparatus includes a first matrix generating means for generating a pseudo-random unitary matrix. A matrix rotating means rotates the first codebook with the pseudo-random unitary matrix. The apparatus includes a means for generating a second codebook based upon the rotated codebook and a correlation matrix. An updating means updates the correlation matrix based on the codeword. A beamforming means performs beamforming based upon the codeword.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 illustrates a simplified block diagram of an exemplary embodiment of an MIMO system using transmit beamforming and receive combining;

FIG. 2 shows a graph of a performance comparison of the fixed and adaptive codebooks in a 3×1, 16-QAM system;

FIG. 3 shows a graph of a performance comparison of the fixed and adaptive codebooks in a 3×3, 16-QAM system;

FIG. 4 shows a graph of a performance comparison of the fixed and adaptive codebooks in a 4×1, 16-QAM system;

FIG. 5 shows a graph of a performance comparison of the fixed and adaptive codebooks in a 4×4, 16-QAM system; and

FIG. 6 shows a simplified block diagram of various electronic devices that are suitable for use in practicing the exemplary embodiments of this invention.

### DETAILED DESCRIPTION

Limited feedback is used to convey some channel information from the receiver to the transmitter. In the optimal case, the transmitter would need to know all the channel estimates; however, as this requires significant feedback overhead and may reduce the PHY data rate, limited feedback can be used to transmit “partial” channel information to the transmitter. This invention proposes a novel limited feedback scheme for such scenarios.

An exemplary embodiment in accordance with this invention is a platform for updating the beamforming codebook in MIMO systems that use limited feedback to efficiently utilize the spatial diversity. This new beamforming technique significantly improves the performance of the PHY transceiver. This invention is described in relation to the WiMAX (IEEE 802.16-type system) and LTE (e.g., E-UTRAN, see, for example, 3GPP TS 36.300 V8.2.0 (2007-09)) as well as any other next generation standard, e.g. IMT Advanced, which uses closed loop beamforming with feedback. However, it should be appreciated that this invention may be used in other wireless communication schemes.

Reference is made to FIG. 6 for illustrating a simplified block diagram of various electronic devices that are suitable for use in practicing the exemplary embodiments of this invention. In FIG. 6 a wireless network 1 is adapted for communication with a UE 10 via a base station (or Node B) 12. The network 1 may include a network control element (NCE) 14. Additionally the NCE 14 may also be connected to other network elements via interface 15.

The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is coupled via a data path 13 to the NCE 14 that also includes a DP 14A and a MEM 14B storing an associated PROG 14C. At least one of the PROGs 10C and 12C is assumed to include program instructions that, when executed by the associated DP, enable the electronic device to operate in accordance with the exemplary embodiments of this invention, as will be discussed below in greater detail.

That is, the exemplary embodiments of this invention may be implemented at least in part by computer software executable by the DP 10A of the UE 10 and by the DP 12A of the Node B 12, or by hardware, or by a combination of software and hardware.

Antenna arrays 10F and 12F represent arrays of at least two antennas for operating in a MIMO systems. The illustration represents single antenna for simplicity and is non-limiting.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

An exemplary embodiment in accordance with this invention may exploit temporary statistical characteristics of the channel to keep the beamforming codebook optimal. In conventional limited feedback methods, a fixed beamforming codebook is designed for all possible realizations of the channel. The fixed codebook is designed such that it is optimal for a general channel model, but it is sub-optimal for each realization of the channel. Although the fixed codebook is optimal when averaging over all possible statistical characteristics of the channel, it is not optimal to use the codebook for temporary periods of time. In an exemplary embodiment in accordance with this invention, an adaptive codebook tracks channel statistical characteristics so that it remains optimal by changing the codebook statistical characteristics.

Simulation results comparing the performance of the conventional fixed codebook vs. the adaptive codebook are presented in FIGS. 2 to 5. The results suggest over 1 dB (up to 2.5 dB) BER performance improvement.

An adaptive beamforming codebook technique relies on updating the beamforming codebook whenever the channel estimates are updated. The feedback mechanism and the number of bits are the same as the conventional closed-loop beamforming technique where a fixed number of bits are used in the feedback link to inform the transmitter of the current codevector.

An exemplary embodiment in accordance with this invention can be implemented using conventional matrix manipulations. The codebook updating, which happens only at a rate equivalent to channel updating in the receiver, consists of regular complex and real multiplications as well as a SVD decomposition to find the rotation matrix. Different realizations of a pseudo-random matrix, U, can be stored in a lookup table, and randomly chosen using conventional VLSI pseudo-random number generators, such as linear feedback shift register (LFSR); thus, generating the same sequence of random numbers such that both transmitter and receiver use the same random matrices.

The pseudo-random unitary matrix, U, may be used to eliminate the bias in the channel estimation bias which is strongly dependent on the initial codebook. Random rotation in both transmitter and receiver removes estimation bias without assuming any specific model for channel variation. Thus, a fixed code book can be updated and will not have an inconsistent biased estimator.

These computations can happen at the channel estimation updating rate, which is considerably lower than the data processing rate. Therefore, using various resource sharing techniques, the silicon complexity of the design can be significantly reduced.

The advantages over conventional solutions are:
Better BER performance: The BER performance improvement over the conventional fixed codebook is significant.
VLSI architecture: There is no significant complexity in the implementation of this algorithm. The major VLSI components of this design are multiplications and SVD decomposition, both of which have been long studied and optimized for different VLSI implementations. Moreover, since the channel coefficients are updated significantly slower than the actual incoming data, the computations, e.g. multiplications and SVD, can be implemented with a very high resource sharing factor, which leads to a small silicon area compared to the rest of the transceiver.

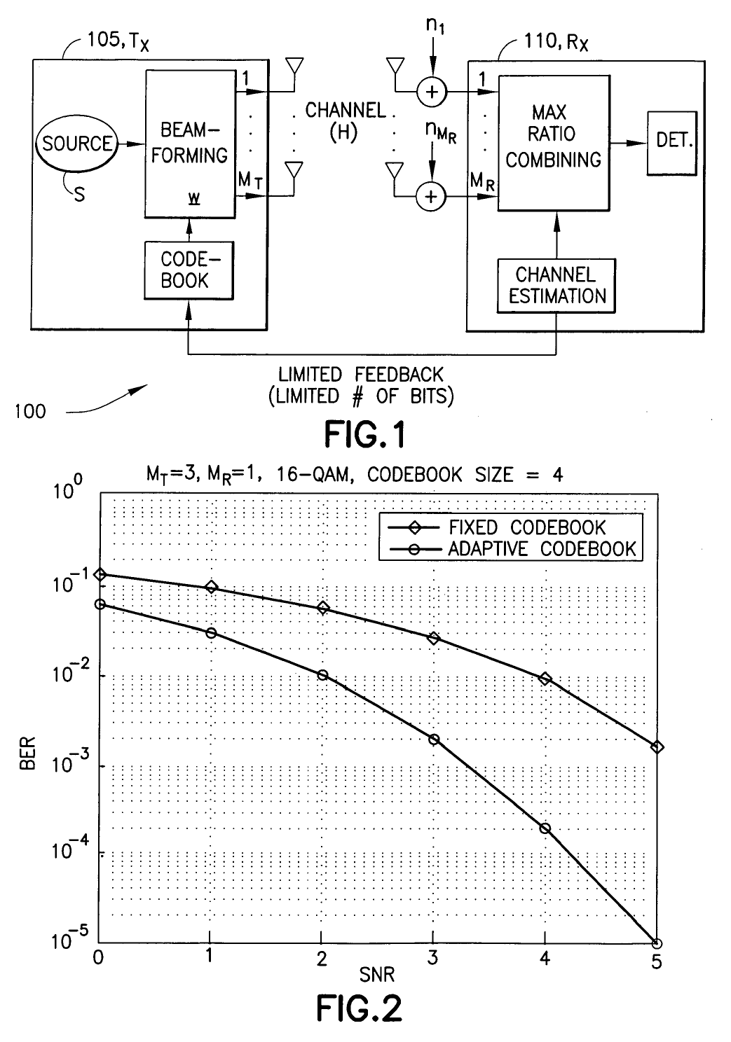

FIG. 1 shows the high-level block diagram of general MIMO wireless receiver 110 and transmitter 105 with limited feedback. The transmission scheme is based on full diversity where a single stream of data is spatially coded over the transmitter antennas. The received vector in the receiver goes through the Maximal Ratio Combining (MRC) which combines the elements of the received vector, for example based:

y=z^{H}Hwᵢs+z^{H}n. (2)

The beamforming vector is chosen in the receiver using the metric given by:

wᵢ=arg max_{uεK}∥Hu∥₂ (3)

The index of the chosen codeword, e.g., a vector, is sent through a dedicated feedback link to the transmitter.

The correlation matrix, Σ, in both the transmitter and the receiver can be used to find a non-uniform codebook, e.g., a codebook whose codewords are around a specific direction. Kᵤ, the codebook matrix, is a matrix with each of its columns corresponding to one of the codewords. Thus, a new codebook, K_{H}, defined below has more codewords around the channel direction:

K_{H}=Σ^{1/2}Kᵤ (4)

Therefore, Σ is found in both the transmitter and the receiver; since they both have the same codebook, the estimation of Σin both transmitter and receiver should be the same as well.

If both the transmitter and the receiver knew the exact channel realization, they could both calculate Σ:

Σ=E{H^{H}H}, (5)

or use the average of the last L channel realizations to estimate the mean:

$$\sum \approx \frac{1}{L} {\sum }_{j = 1}^{L} {H}_{j} {H}_{j}^{H} . \qquad ( 6 )$$

However, having the complete channel information in the transmitter is not a practical assumption. Therefore, Eq. (6) cannot be used to estimate the channel correlation matrix. Eq. (6) can still be used to find an approximation for Σ.

In the limited feedback scenario, the transmitter has information about an approximation of the channel through the feedback link. In other words, using Eq. (3), Hⱼ, the channel at time j, is estimated by wᵢ^{j}, the i-th column of the codebook at time j, and is sent to the transmitter. Thus, both the transmitter and the receiver have a common estimate of the channel. Hence, they can both use this estimation and substitute it in Eq. (6) to estimate Σ,

$$\sum \approx \frac{1}{L} {\sum }_{j = 1}^{L} {( {w}_{j}^{j} )}^{H} {w}_{j}^{j} . \qquad ( 7 )$$

This estimation of Σ is a biased estimate, and the bias itself is a function of the codebook that is used to estimate H. Therefore, the codebook can be changed in both the transmitter and the receiver at the same time and have an unbiased estimation of Σ. In order to have different codebooks, for each channel realization, the codebook is randomly rotated. Since both the transmitter and the receiver should have the same codebook, the random rotation in both sides needs to be the same. Random generators may be used with the same seed in both the transmitter and the receiver; thus, both the transmitter and the receiver use the same pseudo-random matrix, U.

The adaptive codebook algorithm steps are summarized in Tables 1 and 2 for the receiver and transmitter. Two algorithms for the transmitter and the receiver track the optimal codebook. The algorithms are described in detail in Tables I and II. Note: α is a correcting variable.

TABLE I
Initialization
Initialize seed of random generator (the same seed as transmitter)
Set K_{H} = Kᵤ
Set Σₑₛₜ = I
Repeat for each new channel realization
Find channel realization, H
Generate a new pseudo-random unitary matrix, U
Rotate the codebook Kᵤ := UKᵤ
Change the codebook to K_{H} := Σₑₛₜ^{1/2}Kᵤ
Find a codeword, wᵢ, from K_{H} that is the best estimation for H :
wᵢ=arg max_{uεK} ||Hu||₂
Update Σₑₛₜ = (1−α)Σₑₛₜ + αwᵢ^{H} *wᵢ
Send i , index of the codeword in the codebook, to the
transmitter (feedback)

TABLE II
Initialization
Initialize seed of random generator (the same seed as receiver)
Set K_{H} = Kᵤ
Set Σₑₛₜ = I
Repeat each time a new i is received through the feedback
Receive the codeword index, i
Look up wᵢ from the codebook
Generate a new pseudo-random unitary matrix, U
Rotate the codebook Kᵤ := UKᵤ
Change the codebook to K_{H} := Σₑₛₜ^{1/2}Kᵤ
Update Σₑₛₜ = (1−α)Σₑₛₜ + αwᵢ^{H} *wᵢ
Use wᵢ for beamforming

A major property of these algorithms is that there is no need for any extra information in the transmitter and receiver compared to the traditional fixed limited feedback.

FIG. 2, 3, 4 and 5 present BER comparison results for different cases. The channel matrix is assumed to be both spatially and temporally correlated. The codebook size is four.

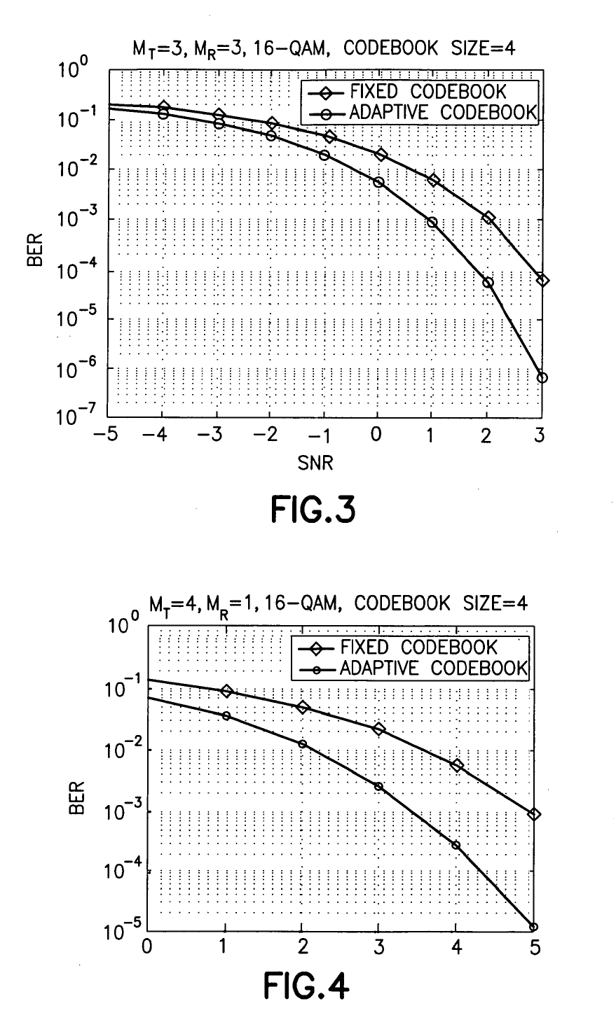

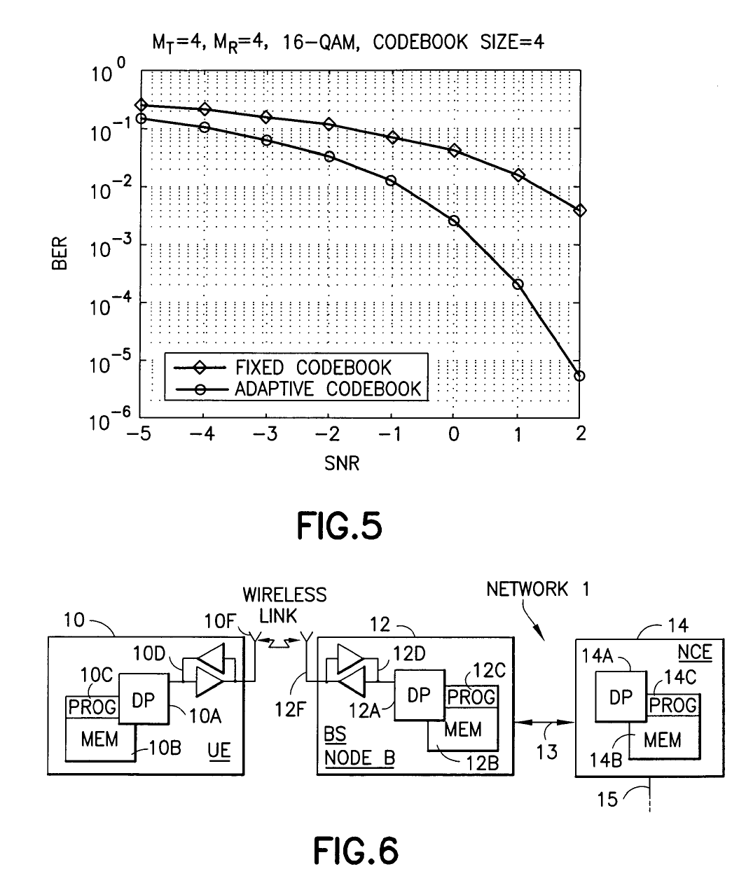

FIG. 2 is a graph of a performance comparison of the fixed and adaptive codebooks in a 3×1, 16-QAM system. FIG. 3 is a graph of a performance comparison of the fixed and adaptive codebooks in a 3×3, 16-QAM system. FIG. 4 is a graph of a performance comparison of the fixed and adaptive codebooks in a 4×1, 16-QAM system. FIG. 5 is a graph of a performance comparison of the fixed and adaptive codebooks in a 4×4, 16-QAM system.

In all the simulations, the codebook size remains the same for both conventional fixed codebook, and the adaptive codebook. During the codebook updating phase, the size of the codebook does not increase, only the four vectors in the codebook change. The simulations assume that the correlation matrix remains fixed throughout the whole simulation. Only the i.i.d. term changes for each transmission. Thus, the overall channel matrix is (H=A*H_iid*B), where A and B are the correlation matrices. During the simulation, A and B are fixed and don't change at all, only H_iid is changed for each new transmission.

An exemplary embodiment in accordance with this invention may be used with any standard which is based on a MIMO system that utilizes diversity. As non-limiting examples the beamforming and limited feedback can be used in WiMAX and 3GPP LTE. Also, next generation wireless standards, such as IMT Advanced, are possible options that can use the adaptive codebook solution to further improve the BER performance.

Moreover, even though the simulation results are for the case of a single data stream coded on multiple antennas, the algorithm can be readily extended to the cases where more streams of data are transmitted, e.g. two streams of data on four transmit antennas.

The exemplary embodiment in accordance with this invention described have been described for applications where a single stream of data is multiplied by the beamforming vector, and transmitted over the multiple transmit antennas of the MIMO system. However, this algorithm can be readily extended to applications that use higher data streams, for instance two streams of data over four transmit antennas and so forth.

An exemplary embodiment in accordance with this invention can be incorporated into the next generation advanced wireless standards which utilize limited feedback and closed-loop beamforming for performance improvement. IMT Advanced is one of such standards that can use this invention without significant complexity overhead. Also, simple closed-loop beamforming schemes have been proposed in WiMAX and 3GPP LTE uplink standards which can be simply modified to match with the solution in this invention.

An exemplary embodiment in accordance with this invention is a method for beamforming. The method includes generating a pseudo-random unitary matrix. A first codebook is rotated with the pseudo-random unitary matrix. The method includes generating a second codebook based upon the rotated codebook and a correlation matrix. A codeword is selected from the second codebook using a channel matrix. The correlation matrix is updated based upon the selected codeword. The method includes transmitting an index of the selected codeword in the codebook.

In a additional exemplary embodiment of the method above, the selecting of the codeword includes identifying the codeword from the second codebook that provides a best estimation of the channel matrix. The selected codeword may satisfy the equation: w₁=arg max_{uεK}∥Hu∥₂, where wᵢ is the codeword, K_{H} is the second codebook, u is a vector in K_{H}, and H is the channel matrix.

In a further exemplary embodiment of any of the methods above, the method also includes updating the correlation matrix. The updating of the correlation matrix may be done by satisfying the equation: Σₑₛₜ=(1−α)Σₑₛₜ+αwᵢ^{H}*wᵢ, where Σₑₛₜ is the correlation matrix, α is a correction term, wᵢ is the selected codeword, and wᵢ^{H} is its vector transpose conjugate.

In an additional exemplary embodiment of any of the methods above, the method also includes initializing a seed of a random generator for use in generating the pseudo-random unitary matrix. An indication of the seed to be used may be received or transmitted. Additionally, the seed may be predetermined.

In a further exemplary embodiment of any of the methods above, the second codebook is generated so that it satisfies the equation: K_{H}:=Σₑₛₜ^{1/2}Kᵤ, where Σₑₛₜ is the correlation matrix and Kᵤ is the rotated codebook.

In an additional exemplary embodiment of any of the methods above, the method is performed as a result of execution of computer program instructions stored in a computer readable memory medium.

Another exemplary embodiment in accordance with this invention is a method for beamforming. The method includes receiving a codeword index. A first codebook is consulted using the codeword index to locate a codeword. The method includes generating a pseudo-random unitary matrix. A first codebook is rotated with the pseudo-random unitary matrix. The method includes generating a second codebook based upon the rotated codebook and a correlation matrix. The correlation matrix is updated based upon the codeword. Beamforming is performed based upon the codeword.

In a further exemplary embodiment of any of the methods above, the method also includes updating the correlation matrix. The updating of the correlation matrix may be done by satisfying the equation: Σₑₛₜ=(1−α)Σₑₛₜ+αwᵢ^{H}*wᵢ, where Σₑₛₜ is the correlation matrix, α is a correction term, wᵢ is the selected codeword, and wᵢ^{H} is its complex transpose conjugate.

In an additional exemplary embodiment of any of the methods above, the method also includes initializing a seed of a random generator for use in generating the pseudo-random unitary matrix. An indication of the seed to be used may be received or transmitted. Additionally, the seed may be predetermined.

In a further exemplary embodiment of any of the methods above, the second codebook is generated so that it satisfies the equation: K_{H}:=Σₑₛₜ^{1/2}Kᵤ, where Σₑₛₜ is the correlation matrix and Kᵤ is the rotated codebook.

In an additional exemplary embodiment of any of the methods above, the method is performed as a result of execution of computer program instructions stored in a computer readable memory medium.

A further exemplary embodiment in accordance with this invention is an apparatus for beamforming. The apparatus includes a processing unit to generate a pseudo-random unitary matrix. The processing unit also rotates a first codebook with the pseudo-random unitary matrix, generates a second codebook based upon the rotated codebook and a correlation matrix, selects a codeword from the second codebook using a channel matrix, and updates the correlation matrix based on the selected codeword. The apparatus also includes a transmitter in the receiver unit configured to transmit an index of the selected codeword in the codebook.

In an additional exemplary embodiment of the apparatus as above, the processing unit identifies the codeword from the second codebook that provides a best estimation of the channel matrix when selecting the codeword.

In a further exemplary embodiment of any of the apparatuses as above, the processing unit also updates the correlation matrix.

In an additional exemplary embodiment of any of the apparatuses as above, the processing unit is also initializes a seed of a random generator for use in generating the pseudo-random unitary matrix. The apparatus may also include a receiver to receive an indication of the seed. Alternatively, the transmitter may transmit the seed to be used. Additionally, the seed may be predetermined.

A further exemplary embodiment in accordance with this invention is an apparatus for beamforming. The apparatus includes a receiver in the transmitter unit to receive an index of the selected codeword in the codebook. The apparatus includes a processing unit to consult a first codebook using the codeword index to locate a codeword. The processing unit also generates a pseudo-random unitary matrix, rotates a first codebook with the pseudo-random unitary matrix, generates a second codebook based upon the rotated codebook and a correlation matrix, and updates the correlation matrix based on the codeword. The apparatus includes a beamforming unit to perform beamforming based upon the codeword.

In an additional a further exemplary embodiment of any of the apparatuses as above, the processing unit also updates the correlation matrix.

In a further exemplary embodiment of any of the apparatuses as above, the processing unit is also initializes a seed of a random generator for use in generating the pseudo-random unitary matrix. The apparatus may also include a transmitter to transmit the seed to be used. Alternatively, the receiver may receive an indication of the seed. Additionally, the seed may be predetermined.

Another exemplary embodiment in accordance with this invention is an apparatus for beamforming. The apparatus includes a means for generating a pseudo-random unitary matrix. A matrix rotating means rotates a first codebook with the pseudo-random unitary matrix. The apparatus includes a means for generating a second codebook based upon the rotated codebook and a correlation matrix. A selecting means selects a codeword from the second codebook using a channel matrix. An updating means updates the correlation matrix based on the selected codeword. The apparatus includes a means for transmitting an index of the selected codeword in the codebook.

A further exemplary embodiment in accordance with this invention is an apparatus for beamforming. The apparatus includes a means for receiving a codeword index. A consulting means consults a first codebook using the codeword index to locate a codeword. The apparatus includes a first matrix generating means for generating a pseudo-random unitary matrix. A matrix rotating means rotates the first codebook with the pseudo-random unitary matrix. The apparatus includes a means for generating a second codebook based upon the rotated codebook and a correlation matrix. An updating means updates the correlation matrix based on the codeword. A beamforming means performs beamforming based upon the codeword.

The exemplary embodiments of the invention, as discussed above and as particularly described with respect to exemplary methods, may be implemented as a computer program product comprising program instructions embodied on a tangible computer-readable medium. Execution of the program instructions (e.g., by a computer processor) results in operations comprising steps of utilizing the exemplary embodiments or steps of the method.

Note again that while the exemplary embodiments have been generally described above in the context of the WiMAX and E-UTRAN (UTRAN-LTE) systems, it should be appreciated that the exemplary embodiments of this invention are not limited for use with only these particular types of wireless communication systems, and that they may be used to advantage in other wireless communication systems.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

1-35. (canceled)

36. A method comprising:
generating a pseudo-random unitary matrix;
rotating a first codebook with the pseudo-random unitary matrix;
generating a second codebook based upon the rotated codebook and a correlation matrix;
selecting a codeword from the second codebook using a channel matrix;
updating the correlation matrix based upon the selected codeword; and
transmitting an index of the selected codeword in the codebook.

37. The method of claim 36, wherein selecting the codeword comprises identifying the codeword from the second codebook that provides a best estimation of the channel matrix.

38. The method of claim 37, wherein the selected codeword satisfies the equation:
wᵢ=arg max_{uεK}∥Hu∥₂, where wᵢ is the codeword, K_{H} is the second codebook, u is a vector in K_{H}, and H is the channel matrix.

39. The method of claim 36, further comprising updating the correlation matrix.

40. The method of claim 39, wherein updating the correlation matrix by satisfying the equation: Σₑₛₜ=(1−α)Σₑₛₜ+αwᵢ^{H}*wᵢ, where Σₑₛₜ is the correlation matrix, α is a correction term, wᵢ is the selected codeword, and wᵢ^{H} is a transpose conjugate.

41. The method of claim 36, further comprising initializing a seed of a random generator for use in generating the pseudo-random unitary matrix.

42. The method of claim 41, further comprising one of receiving and transmitting an indication of the seed to be used.

43. The method of claim 36, wherein generating the second codebook satisfies the equation: K_{H}:=Eₑₛₜ^{1/2}Kᵤ, where Σₑₛₜ is the correlation matrix and Kᵤ, is the rotated codebook.

44. A method comprising:
receiving a codeword index;
consulting a first codebook using the codeword index to locate a codeword;
generating a pseudo-random unitary matrix;
rotating the first codebook with the pseudo-random unitary matrix;
generating a second codebook based upon the rotated codebook and a correlation matrix;
updating the correlation matrix based on the codeword; and
performing beamforming based upon the codeword.

45. The method of claim 44, further comprising updating the correlation matrix.

46. The method of claim 45, wherein updating the correlation matrix satisfies the equation: Σₑₛₜ=(1−α)+αwᵢ^{H}*wᵢ, where Σₑₛₜ is the correlation matrix, α is a correction term, wᵢ is the selected codeword, and wᵢ^{H} is a transpose conjugate.

47. The method of claim 44, further comprising initializing a seed of a random generator for use in generating the pseudo-random unitary matrix.

48. The method of claim 47, further comprising one of receiving and transmitting an indication of the seed to be used.

49. The method of claim 44, wherein generating the second codebook satisfies the equation: K_{H}:=Σₑₛₜ^{1/2}Kᵤ, where Σₑₛₜ is the correlation matrix and Kᵤ is the rotated codebook.

50. An apparatus comprising:
a processing unit configured to generate a pseudo-random unitary matrix, to rotate a first codebook with the pseudo-random unitary matrix, to generate a second codebook based upon the rotated codebook and a correlation matrix, to select a codeword from the second codebook using a channel matrix and to update the correlation matrix based on the codeword; and
a transmitter configured to transmit an index of the selected codeword in the codebook.

51. The apparatus of claim 50, wherein the processing unit is further configured to identify the codeword from the second codebook that provides a best estimation of the channel matrix when selecting the codeword.

52. The apparatus of claim 50, wherein the processing unit is further configured to update the correlation matrix.

53. The apparatus of claim 50, wherein the processing unit is further configured to initialize a seed of a random generator for use in generating the pseudo-random unitary matrix.

54. The apparatus of claim 53, further comprising a receiver configured to receive an indication of the seed to be used.

55. The apparatus of claim 54, wherein the transmitter is further configured to transmit an indication of the seed to be used.
